(19) United States
(12) Patent Application Publication
(10) Pub. No.: US 2008/0221940 A1
(43) Pub. Date: Sep. 11, 2008

(54) SYSTEM AND METHOD FOR USING THE COMPONENT BUSINESS MODEL TO ANALYZE BUSINESS VALUE DRIVERS

(76) Inventors: David L. Cohn, Dobbs Ferry, NY (US); Robert Delamarter Dill, Raleigh, NC (US); George M. Galambos, Montreal (CA); Robert H. Guttman, Stamford, CT (US); Raman Harishankar, Blacklick, OH (US); David Robert Kress, Carmel, IN (US); Clifford Alan Pickover, Yorktown Heights, NY (US); Simon Plackett, Warwickshire (GB); Guy Jonathan James Rackham, New York, NY (US); Shanker Ramamurthy, New York, NY (US); John R. Smith, New York, NY (US); Stephen Michael Smith, Westlake Village, CA (US); John George Vergo, Yorktown Heights, NY (US)

Correspondence Address: Whitham, Curtis, Christofferson & Cook, P.C., Suite 340, 11491 Sunset Hills Road, Reston, VA, 20190, US

(21) Appl. No.: 11/684,004

(22) Filed: Mar. 8, 2007

(51) Int. Cl. G06F 19/00

(52) U.S. Cl. 705/7

(57) ABSTRACT

The method and system uses the component business model as a framework for locating business activities. Business value drivers are identified, related in an influence model, and structured into a prioritized driver tree. The driver tree is used to determine the relative contributions of leaf drivers to the overall value of the business. Business activities contributing to the leaf drivers are then identified, and the relative contributions of the leaf drivers are allocated to the business activities and then rolled up to the components for display as a heat map overlay on a component map.

This invention is related to commonly owned patent application Ser. No. 11/176,371 for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to component based business models and, more particularly, to using a component business model as a tool for analyzing business value drivers.

2. Background Description

Modern business enterprises are complex systems, yet it is difficult to grasp the system as a whole in order to manage the enterprise effectively. Modeling tools have been developed to assist in the management of complex systems, but existing approaches to business modeling represent an organization in terms of a specific dimension and/or property (e.g. its systems, organization structure, or geographic footprint) or in terms of particular themes and key processes (e.g. risk exposure, capital deployed, new product development and deployment). But these approaches do not attempt to analyze the interdependencies between differing aspects (such as people/process/technology) in a common perspective. A common perspective exposes the synergies between these differing aspects of the business.

### SUMMARY OF THE INVENTION

It is therefore an object of the present invention to provide a methodology for analyzing differing aspects of a business from a common perspective.

Another aspect of the invention is to provide an analysis of a business that exposes synergies between differing aspects of the business.

A further aspect of the invention is to provide a representation of the business that is not limited to particular dimensions, properties, themes or key processes.

One implementation of the invention is a method for using value drivers to create value for a business by selecting priority value drivers for a business; developing an influence model showing how the selected value drivers influence one another; structuring the influence model to provide a link from a measure of overall business value through levels of branches to a plurality of leaf value drivers; distributing to the leaf value drivers a relative contribution to the overall business value; and mapping the leaf value drivers to a component map of the business, such that the relative contributions of the leaf value drivers are aggregated by component. An aspect of this implementation is selecting priority value drivers by using a strategy map to categorize each value driver by impact on a value of the business, and selecting those value drivers having a high impact on the creation of value for the business, such that each driver has a value that varies up or down over time, the variation in value having a clear link to creation of value for the business.

In a further aspect of the invention the influence model comprises an influence diagram showing for each of the value drivers how the variation in value affects a variation in value for each other value driver. In yet another aspect the structuring forms the selected value drivers into a prioritized driver tree. It is also an aspect of the invention to implement the distribution to leaf drivers by determining relative contributions of each branch within a level and cascading relative contributions of value drivers at intervening branches from the overall business value to each leaf driver.

In another aspect of the invention the mapping of leaf value drivers is implemented by identifying business activities contributing to each leaf driver, each identified business activity being performed in a component; determining for each leaf driver relative contributions of each business activity identified as contributing to said leaf driver; combining the distributed leaf driver value with the relative contribution of each business activity to produce an activity score for each business activity contributing to the leaf driver; aggregating activity scores by component; and using the aggregated activity scores to overlay a heat map upon the component map of the business. In a variation upon this implementation the relative contributions are expressed as percentages and the heat map overlay is established by defining a higher and a lower threshold percentage, with those components having relative contributions above the higher threshold being distinguished on the component map from those components having relative contributions between the higher and lower thresholds, and being further distinguished on the component map from those components having relative contributions below the lower threshold.

The invention may also be implemented as a system having means for selecting priority value drivers for a business; means for developing an influence model showing how the selected value drivers influence one another; means for structuring the influence model to provide a link from a measure of overall business value through levels of branches to a plurality of leaf value drivers; means for distributing to the leaf value drivers a relative contribution to the overall business value; and means for mapping the leaf value drivers to a component map of the business, wherein the relative contributions of the leaf value drivers are aggregated by component.

It is also an aspect of the invention to implement a service for using value drivers to create value for a business by selecting priority value drivers for a business; developing an influence model showing how the selected value drivers influence one another; structuring the influence model to provide a link from a measure of overall business value through levels of branches to a plurality of leaf value drivers; distributing to the leaf value drivers a relative contribution to the overall business value; and mapping the leaf value drivers to a component map of the business, wherein the relative contributions of the leaf value drivers are aggregated by component.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart of a value driver analysis of a business showing the outputs associated with steps in the process.

FIG. 2 is a schematic representation of a strategy map showing an exemplar portion of a business.

FIG. 3A is a schematic representation of a matrix for identifying value drivers having a high impact on creation of value for a business; FIG. 3B is an exemplar grouping of identified high impact value drivers.

FIG. 4A is a schematic diagram showing how the value drivers identified in FIG. 3B influence one another.

FIGS. 4B, 4C and 4D are diagrams showing selected examples of the relationships shown in FIG. 4A; FIG. 4B is an example of positive and negative influences upon a value driver; FIG. 4C shows a reinforcing loop relationship between value drivers; FIG. 4D shows a balancing loop relationship between value drivers.

FIG. 5A is a schematic representation of a value driver tree showing the value drivers of FIG. 3B arranged in a branch and leaf style; FIG. 5B annotates the value drivers in FIG. 5A with relative weights of each branch being divided among the leaves.

FIG. 6 is a schematic representation of high level portions of a prioritized value driver tree branching from shareholder value.

FIG. 7 is a chart showing contributions of “leaf” drivers in a value driver tree to creation of value for a business.

FIG. 8A is a partial expansion of the chart in

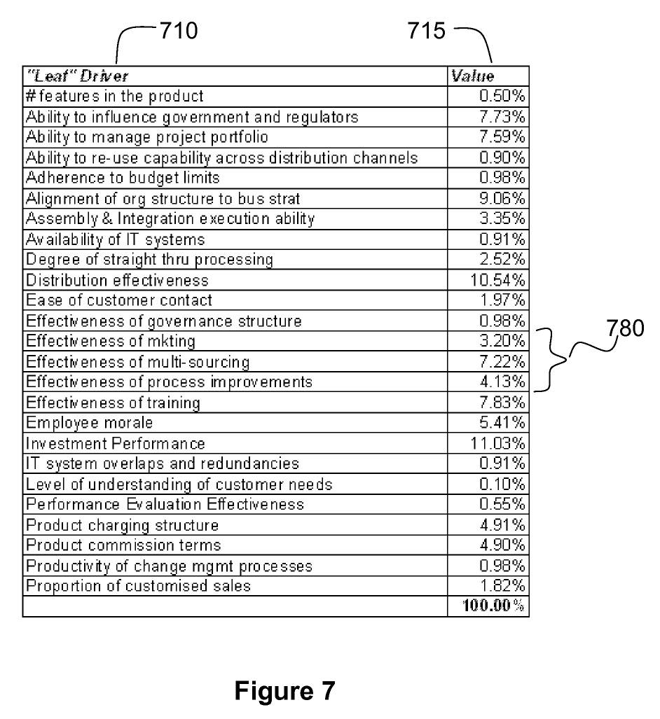

FIG. 7, showing how the value of a leaf driver is allocated to business activities.

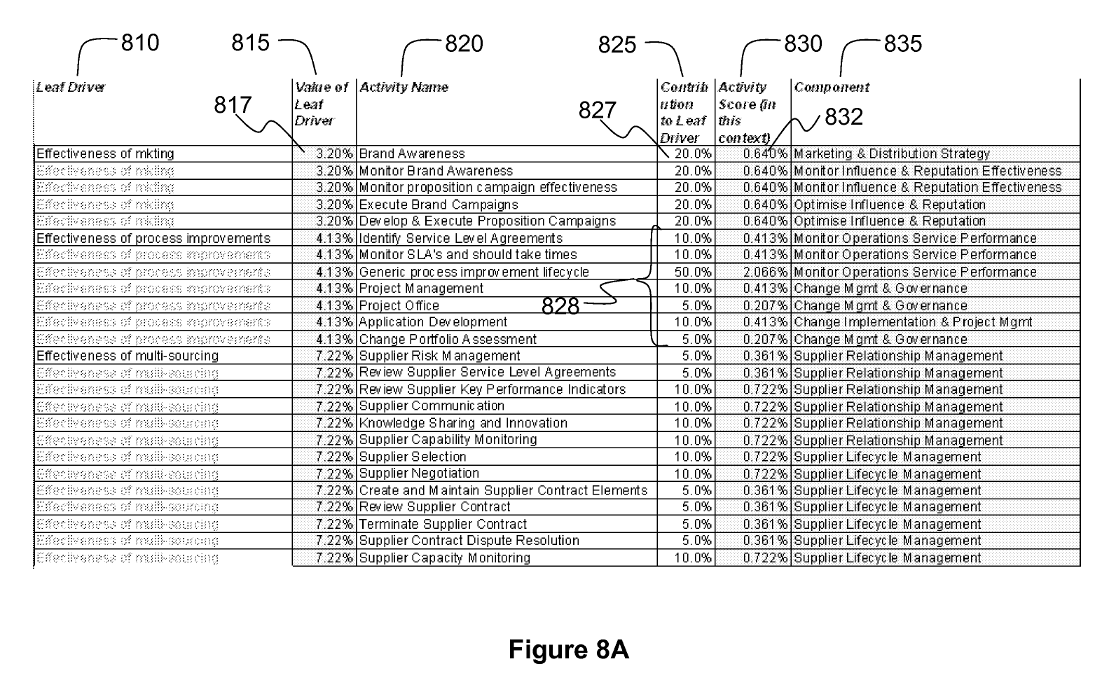

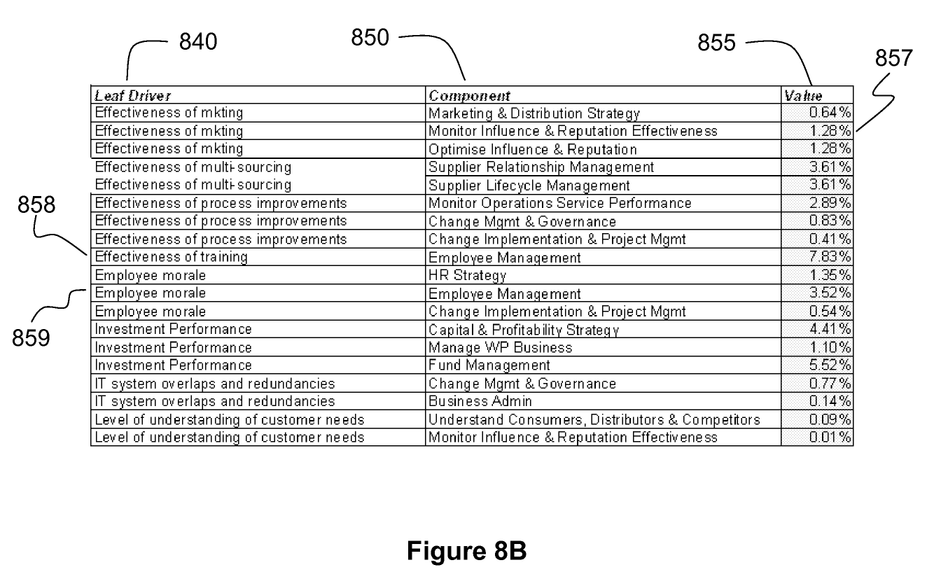

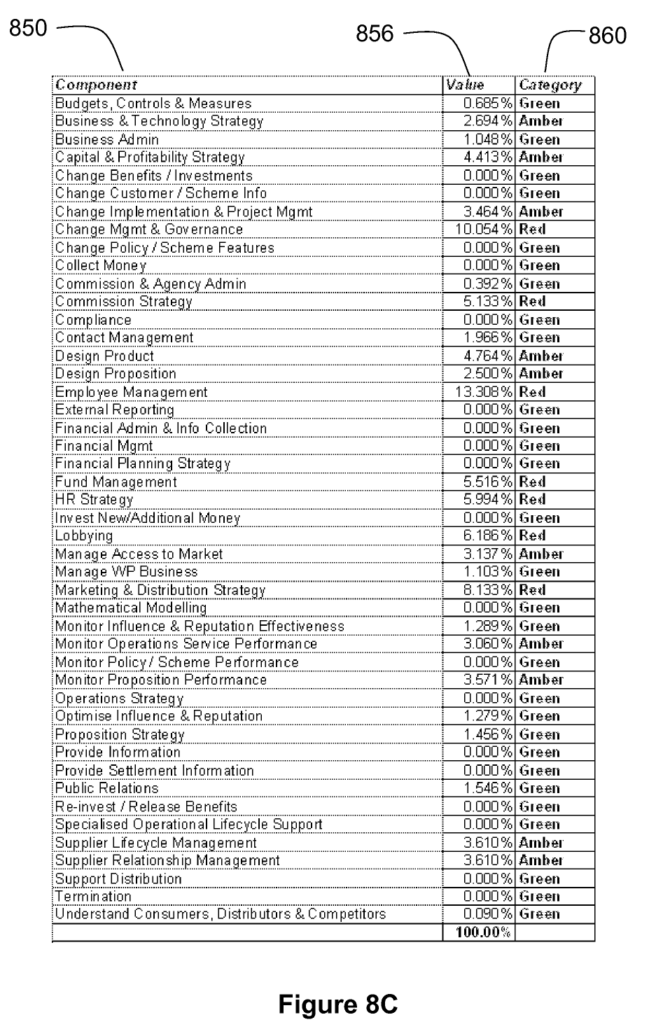

FIG. 8B is a chart showing how the value of a leaf driver is allocated to business components.

FIG. 8C is a chart showing how leaf driver values are rolled up to business components and categorized for a heat map overlay.

### DETAILED DESCRIPTION OF A PREFERRED EMBODIMENT OF THE INVENTION

The invention uses the Component Business Model (CBM) described in related patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across commercial enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important to emphasize that the boundaries between managing concepts (and between components within managing concepts) are logical rather than physical.

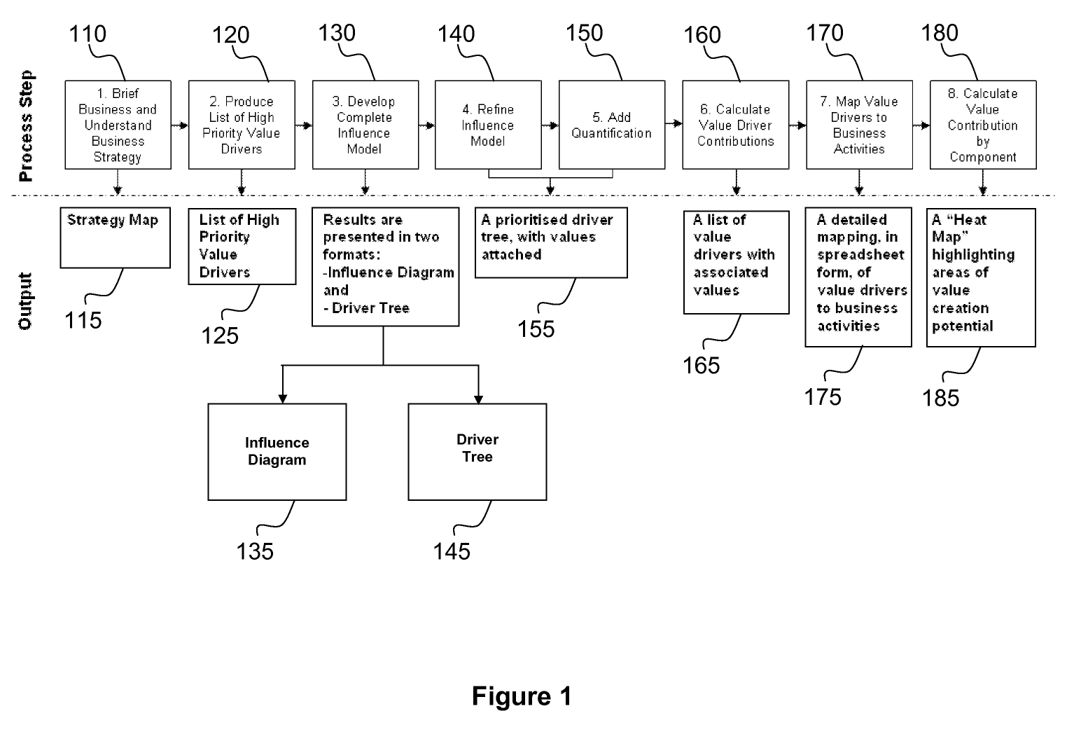

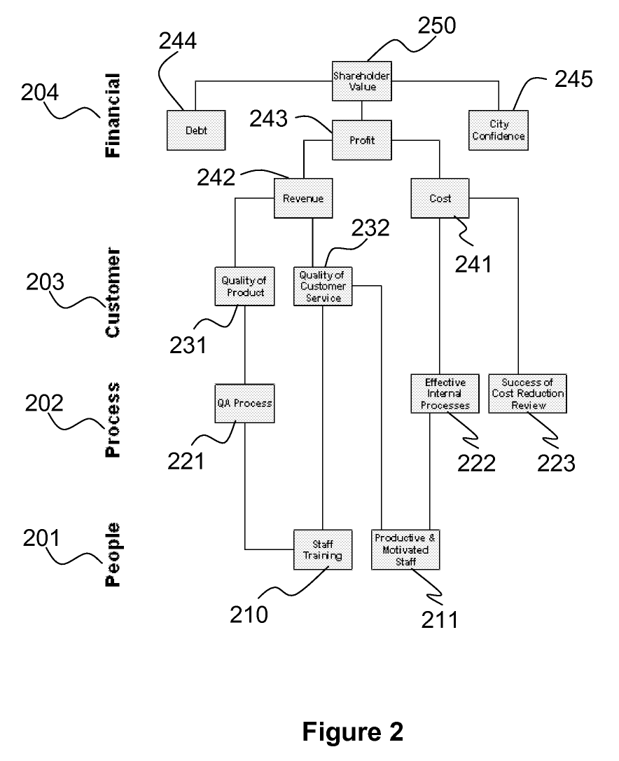

Referring now to the drawings, and more particularly to FIG. 1, there is shown a flow chart of a value driver analysis in accordance with the invention. The overall objective of the process is to represent business strategy in terms of value drivers mapped to a CBM model of the business. This process identifies which activities of the business have the most value creation potential. The first step 110 is to brief the business and its performance and to understand the strategy of the business. The result of this step is a strategy map 115, as shown in FIG. 2.

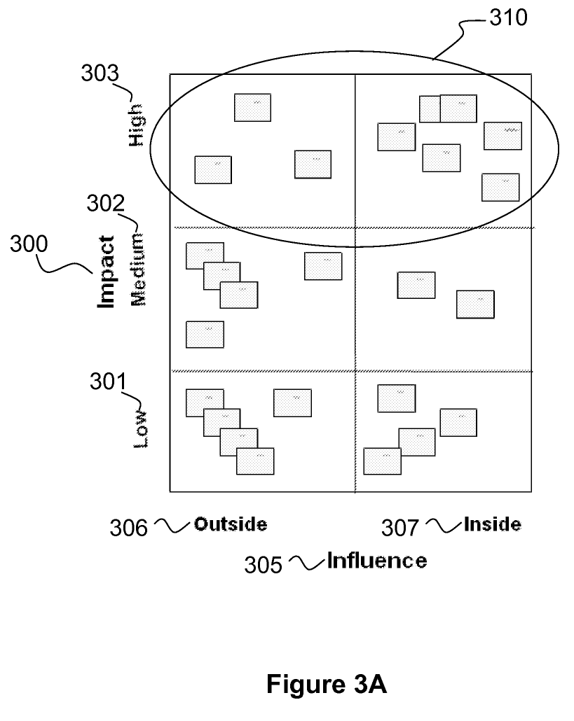

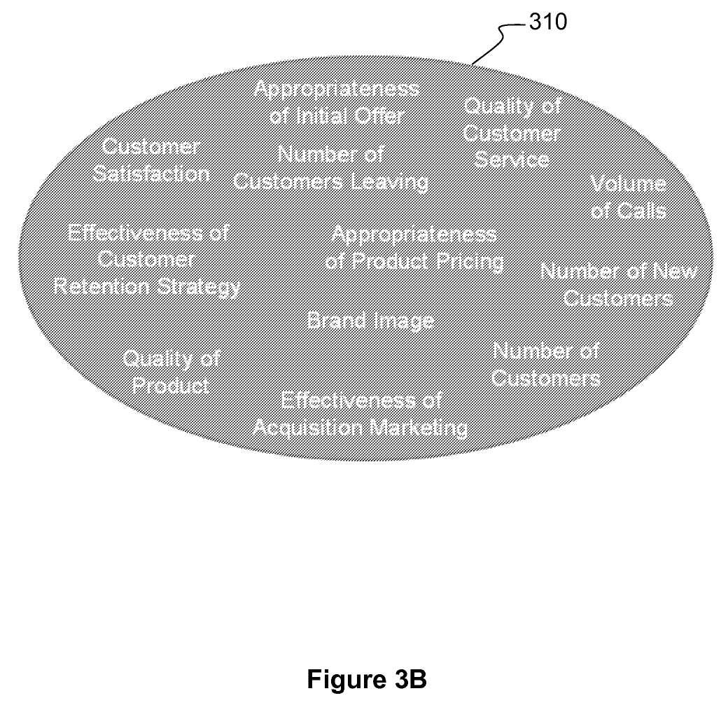

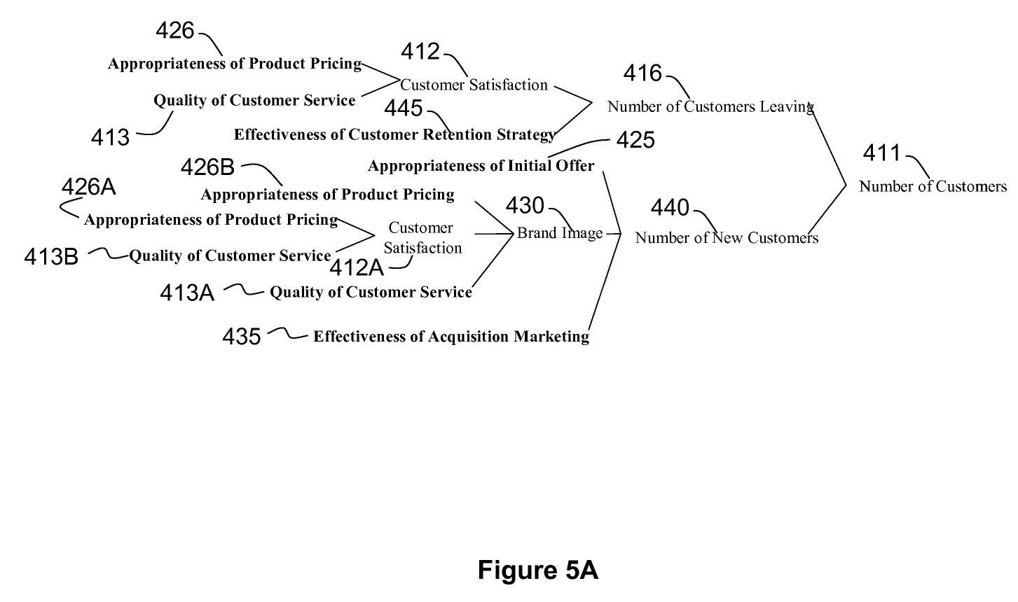

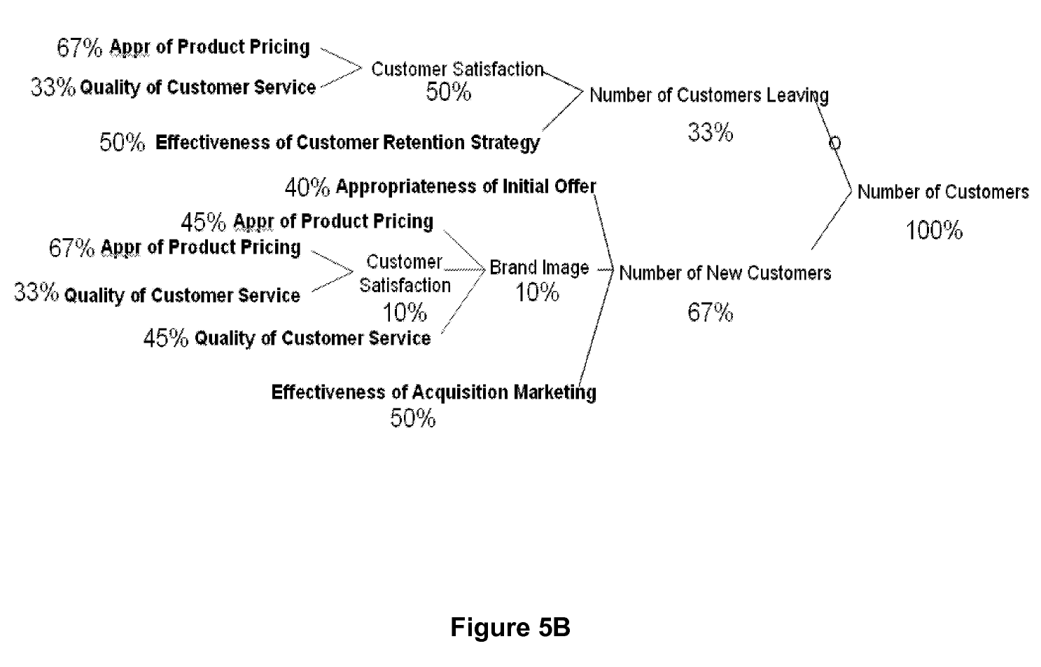

The second step 120 is to produce a list of high priority value drivers 125, as further shown with respect to FIGS. 3A and 3B. A “value driver” for the purposes of the present invention has a number of characteristics. It is a variable which may act or be acted upon. It has a value which varies up or down over time. It has a clear (but not necessarily direct) link to the creation of value for the business. Further, it should be expressed as a noun or noun phrase, such as “customer satisfaction”, “quality of product”, or other such designations as shown on FIGS. 3B and 5A.

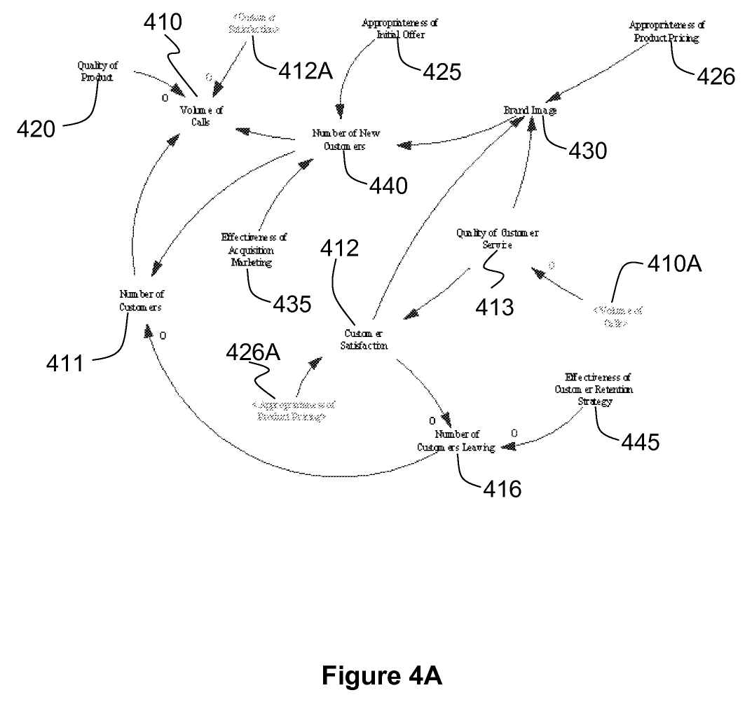

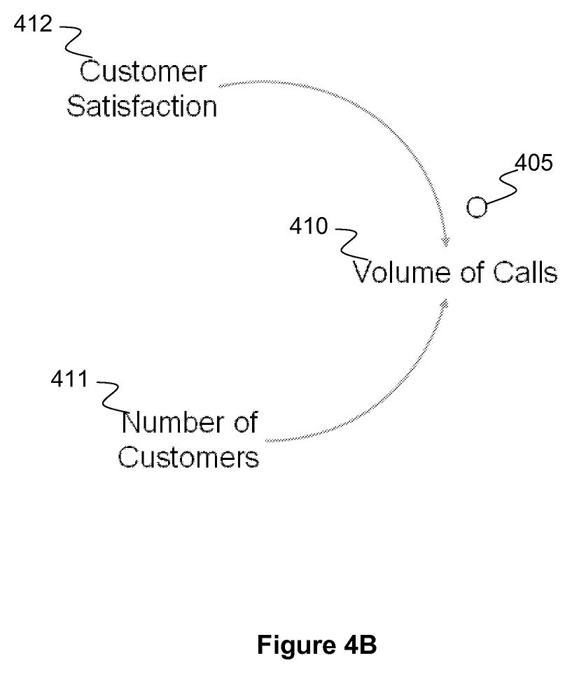

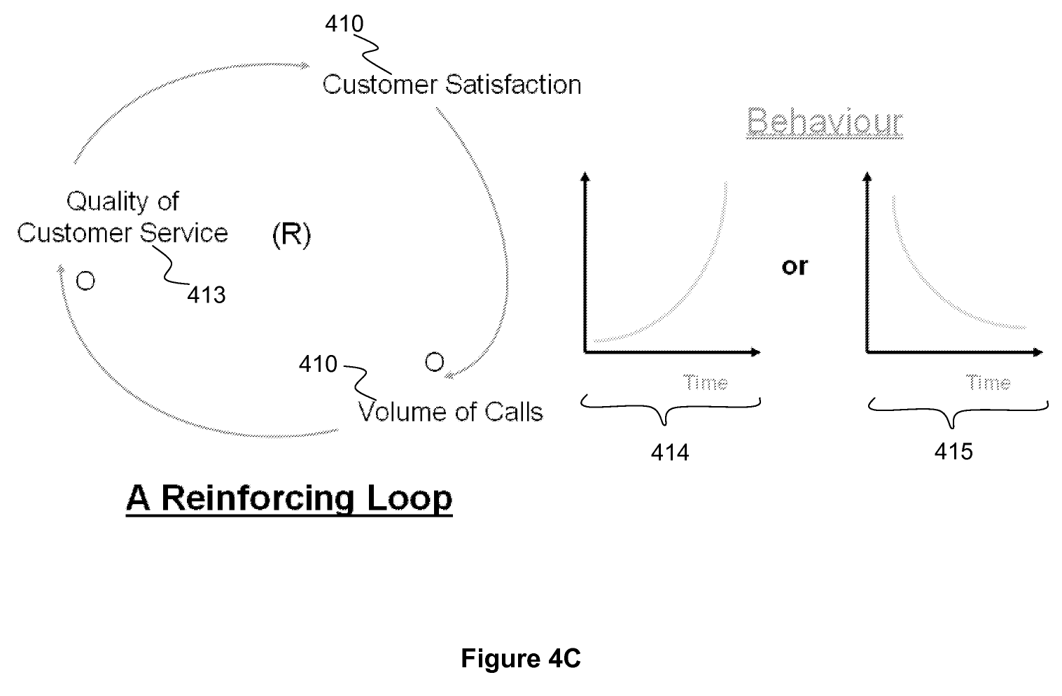

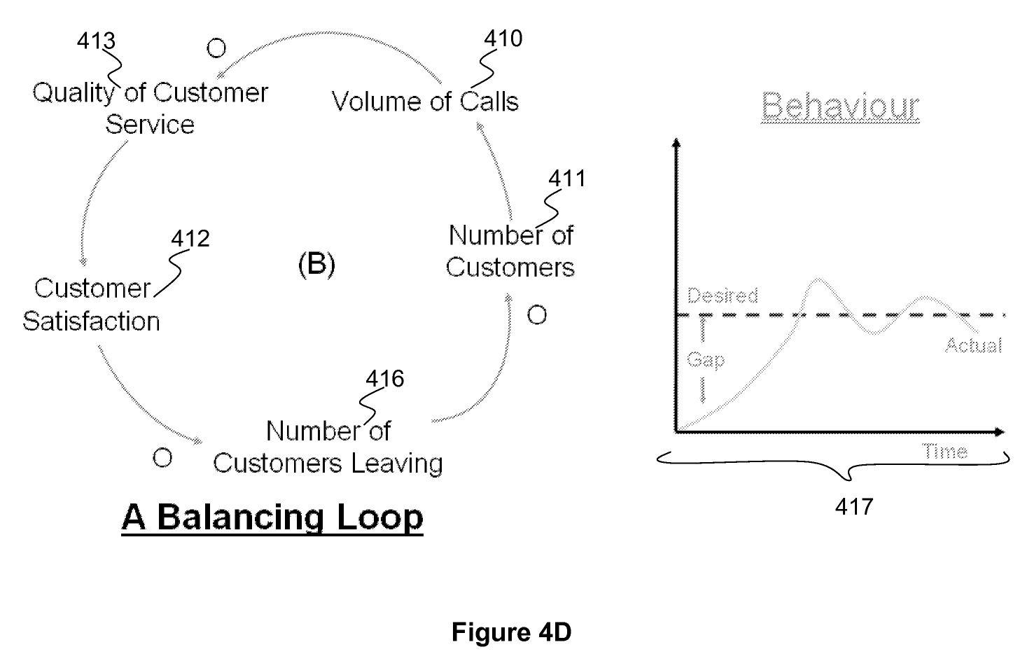

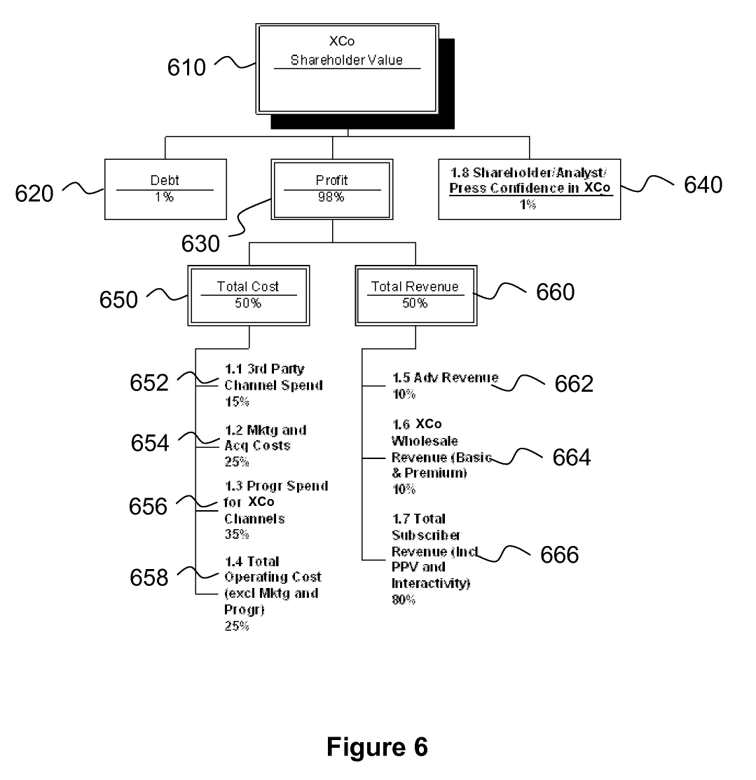

The third step 130 is development of a complete model of how one value driver influences another, as further described in connection with FIGS. 4A and 5A. These influences may be positive or negative, and are assessed individually, with all other value drivers held constant. The output of this step is an influence diagram 135, as shown in FIG. 4A, which is converted into a driver tree 145, as shown in FIG. 5A. The influence model is then refined 140 and quantified 150, resulting in a prioritized driver tree with values attached 155, as further shown in FIGS. 5B and 6. In step six 160 detailed value driver contributions are calculated, producing a list of value drivers with associated values, as further described with respect to FIG. 7. The value drivers are then mapped to business activities in a seventh step 170, producing a detailed mapping of value drivers to business activities and components 175. This step is further described in connection with FIG. 8. Finally, in an eighth step 180, based on the detailed mapping 175, the value contribution is calculated by component, producing a “heat map” 185 highlighting components having the greatest value creation potential, as further described in connection with FIG. 9.

The foregoing process will now be described in greater detail. FIG. 2 shows a strategy map that indicates how certain strategic factors controllable by the business are related to measures of shareholder value for a generic business entity. The purpose of this initial visualization is to serve as a vehicle for making sure that the business managers of the entity have a common understanding of the context within which the invention is to be applied and a common starting point for generating a list of value drivers. It is therefore preferable that this initial strategy map be constructed from strategy descriptions provided by the business managers in a setting where all the business managers who will be involved in the value driver identification project are present. If the business entity has a well-articulated or documented strategy, this step may consist in briefing the participants on a strategy map derived from the prior articulation and documentation.

In the example given in FIG. 2, staff training 210 and a productive and motivated staff 211 are identified as strategic factors related to the people 201 in the business. Within the area of business processes 202, the strategic factors identified are the quality assurance process 221, effective internal processes 222, and the success of cost reduction review 223. Quality of product 231 and quality of customer service 232 have been identified as customer 203 related strategic factors. These factors drive cost 241, revenue 242 and profit 243, which are themselves strategic financial 204 factors. Profit 243, together with debt 244 and stakeholder (i.e., in this particular business, the local city) confidence 245 in the business determine shareholder value 250.

With an understanding of the business as documented in the strategy map, the next step 120 is to produce a list of high priority value drivers having the above described “value driver” attributes. An exemplar tool for doing this is shown in FIG. 3A, which is a matrix for categorizing value drivers. First, a list of potential value drivers is generated. Preferably, this list is prepared using the strategy map as a starting point, but may also be generated directly from existing strategy documentation or simply as a byproduct of a brainstorming session. Second, the breadth of coverage of the list of value drivers is checked. This may be done by mapping the listed value drivers to a high level decomposition of an activity model of the business. Since the Component Business Model (CBM) is comprised of components arranged by competency and management level, and each component is a cohesive grouping of business activities, a rough placement of value drivers on a CBM map may indicate gaps or concentrations of value drivers that should be checked with managers of the business entity.

Third, the draft list is then prioritized. Each driver on the list is roughly categorized as having a high 303, medium 302 or low 301 impact 300 on the primary objectives of the business. Drivers having low impact 301 can be discarded. Medium impact 302 drivers should be re-assessed as either high 303 or low 301. The resulting set of high impact 303 drivers is then examined to see if they are inside 307 or outside 306 the scope of the organization's influence 305. Outside drivers 306 can be translated into inside drivers 307, which represent mitigating action the business can take in response to drivers outside 306 the span of the organization's control.

The name given to a translated outside driver 306 should reflect the mitigating action. For example, if “Regulatory Requirements” is an outside driver 306, the translated driver might be “Compliance with Regulatory Requirements”. Wording of drivers can be important. “Spend” may prove to be less contentious than “cost” or “budget” in the driver “Marketing Spend”. Also, wording is important because the business managers of the entity may be more interested in “Effectiveness of Marketing Spend” than in “Marketing Spend”. It may help to reword drivers to make their meaning explicit. It is also preferable at this stage to check to see that the value drivers can be mapped to business activities. This mapping will be more evident if the wording of the value drivers is taken from terminology used in the description of components and business activities in the CBM model.

The high impact value drivers 310 identified using the foregoing process and matrix shown in FIG. 2 provide a high priority list. For the purposes of explanation, a partial exemplar of such a list is shown in FIG. 3B. This list is then used (in the third step 130) to develop a complete influence model showing the relationships between and among the high priority value drivers.

A partial influence model is shown in FIG. 4A, corresponding to the high priority value drivers identified in FIG. 3B. The positive influence of one value driver upon another is indicated by an arrow in the direction of the positively influenced value driver. If the influence is negative, a “0” is shown next to the arrow head. The volume of calls 410 is positively influenced by quality of product 420, number of customers 411, and number of new customers 440, and is negatively influenced by customer satisfaction 412A. The number of new customers 440 is positively influenced by the appropriateness of the initial offer 425, brand image 430, and effectiveness of acquisition marketing 435.

Brand image 430 is positively influenced by appropriateness of product pricing 426, quality of customer service 413 and customer satisfaction 412. Quality of customer service 413 is negatively influenced by the volume of calls 410A. Customer satisfaction 412 is positively influenced by the quality of customer service 413 and the appropriateness of product pricing 426A. The number of customers leaving 416 is negatively influenced by the effectiveness of the customer retention strategy 445 and customer satisfaction 412.

These relationships may be understood by reference to FIGS. 4B, 4C and 4D. For example, as shown in FIG. 4B, the volume of calls 410 from customers may be a high priority driver, along with the number of customers 411 and customer satisfaction 412. A higher number of customers 411 will increase the volume of calls 410, and therefore those two value drivers (410 and 411) are positively related, as shown by the arrow (from 411 to 410). And while an increase in the number of customers 411 will have a positive influence on the volume of calls 410, an increase in customer satisfaction 412 will have the opposite effect on the volume of calls 410. This negative influence (from 412 to 410) is noted by the “0” 405. Put another way, if customers are unhappy they will complain, resulting in more calls; similarly, if customers are not retained, they will not place orders and there will be fewer calls as a result.

To reduce the volume of calls 410 due to unhappy customers, it is necessary to increase the quality of customer service 413, which in turn increases customer satisfaction 412. This reinforcing behavior is shown in the reinforcing loop in FIG. 4C. Note the negative relationship between volume of calls 410 and quality of customer service 413, i.e. a decrease in complaint calls reflects an increase in the quality of customer service 413. Note also the positive relationship between an increase in the quality of customer service 413 and an increase in customer satisfaction 412. Over time, efforts to increase the quality of customer service 413 will result in an increase in customer satisfaction 412, as shown in the behavior graph 414, and a decrease in the volume of calls 410, as shown in the behavior graph 415. The loop is tied together by the negative connection between the volume of calls 410 and the quality of customer service 413, where a decreasing volume of calls 410 corresponds to an increase in the quality of customer service 413. That is, efforts to increase the quality of customer service 413 are reinforced by a decrease in the volume of calls 410 resulting from an increase in customer satisfaction 412.

However, as shown in FIG. 4B, the volume of calls 410 is positively related to the number of customers 411. Thus, it is desirable to achieve a balance between two opposing components of volume of calls 410: more customers but fewer complaints, as shown in FIG. 4D. The quality of customer service 413 has a positive effect on customer satisfaction 412, which in turn can be expected to reduce the number of customers leaving 416 (i.e. there is a negative relationship between customer satisfaction 412 and the number of customers leaving 416). In turn, a reduction in the number of customers leaving 416 can be expected to have the opposite effect on the number of customers 411 (i.e. there is a negative relationship between the number of customers leaving 416 and the number of customers 411). The net result is shown in the behavior graph 417, where the effect over time of efforts to increase the quality of customer service 413 is to attain a level of volume of calls 410 that is balanced between more calls from retained customers and fewer calls from unhappy customers.

For a given number of customers, the desired call level would reflect a high proportion of orders received from satisfied customers coupled with a low proportion of complaints from customers who are not satisfied. Efforts to improve the quality of customer service should drive the call level toward this desired level, as shown in behavior graph 417. Given normal variation in ordering frequency even from satisfied customers, and normal variation in complaint frequency, there will be some oscillation in the approach over time to the desired level. But on average the call frequency should approach the desired level.

Returning to FIG. 4A, the high priority value drivers identified in the second step 120 are represented in a graphic space to allow the influences between drivers to be shown. Although a two dimensional graphic space is shown in FIG. 4A, those skilled in the art will appreciate that representational tools displaying more than two dimensions may be used to advantage in describing complex influence relationships among value drivers. For the purposes of example, the value drivers identified in FIG. 3B are being shown. Note that additional “copies” of value drivers are indicated between angle brackets (e.g. 410A, 412A, and 426A). As those skilled in the art will appreciate, this technique reduces complexity of a two dimensional display.

It should be noted that there can be no closed loops in an influence diagram. An important aspect of refining the influence diagram is to identify and break closed loops. The refinement process will then result in identification of a dominant driver to be placed at the apex of a driver tree presentation, as illustrated below in FIG. 5A.

Returning to FIG. 1, the influence diagram 135 shown in FIG. 4A is one format for presentation of the influence model. It should be noted that these relationships may also be represented and stored in the form of a simple relational table (not shown). Another format for presentation of the influence model is the driver tree, which will now be described with reference to FIG. 5A.

FIG. 5A is built from the number of customers 411, and shows the value drivers influencing the number of customers, namely, the number of new customers 440 and the number of customers leaving 416. The remaining relationships shown in FIG. 5A are described above in connection with FIG. 4A. Note that additional “copies” of some value drivers are shown within parentheses (e.g. Appropriateness of Product Pricing 426A, Customer Satisfaction 412A, and Quality of Customer Service 413A). Also note that by constructing the tree from the Number of Customers 411, value drivers which do not influence the Number of Customers (i.e. Volume of Calls 410 and Quality of Product 420) do not appear in the tree.

It will be observed that in general there may be a variety of ways to convert the influence diagram 135 into a driver tree 145. FIG. 5A presents a driver tree beginning with number of customers 411 as the primary node. However, a similar driver tree could be developed by beginning with a different node, such as brand image 430, reflecting a different prioritization of drivers.

It will be recalled that the influence diagram in FIG. 4A is only a partial diagram of a business, for the purposes of clarity in illustrating the operation of the invention. It will be evident to those skilled in the art that in a full influence diagram there will be a value driver node corresponding to a “bottom line” of value for the business, and this value driver would be used as the primary node for building a complete driver tree. See FIG. 6 for an example of a tree built from the primary node of Shareholder Value 610 for a hypothetical company XCo.

It will be noted from FIG. 1 that the next steps following development of a complete influence model 130, and presenting the model in the form of an influence diagram 135 (shown in FIG. 4A) and a driver tree 145 (shown in FIG. 5A), are to refine the influence model 140 and add quantification 150. The output of these steps is a prioritized driver tree 155, with values attached.

In order to refine the influence model 140 it is necessary to ask three questions. The first question is to ask of each listed value driver whether this driver is one that the business is choosing to drive today and in the current strategic timeline. However valuable a driver may be in principle, if during the current strategic timeline the managers of the business are not going to address it the driver should not be retained as a high priority in the influence model. Similarly, if another driver is going to be a focus of management attention, even if initially evaluated as having only medium or low impact and excluded from the high priority list, then this other driver should be added to the influence model.

The second question is whether changes to the value driver in the context of the current strategic timeline can make a significant contribution to the value of the business. For example, investment in changes to the way the business interacts with customers may be ignored by management in some contexts, yet may serve as a primary value driver when the marketplace is transitioning from a storefront to an Internet based sales methodology. The current strategic timeline may mean that a value driver that appears prominently in a documented policy will be downgraded and replaced with a different value driver judged by business managers to be more pressing in the current strategic timeline.

The third question to be asked of each value driver is whether there is headroom for movement with this driver. A driver that is important but has recently been optimized will likely have less potential for adding value to the business than another driver that will more readily respond to management efforts to make changes, thereby offering more substantial prospects for positive change. For example, headroom may have opened up for a particular driver because of recent changes in market conditions. Such changes in market conditions may have prompted the business managers to consider applying the present invention.

Once the value drivers in the influence model 130 are refined 140, the driver tree structure best reflecting the business priorities among the drivers is selected. The prioritized driver tree is then annotated 150 with estimates showing how each leaf driver contributes to each node to which the leaf is connected and how each of these nodes contributes to the next node up the tree, and in like fashion to the top of the tree. This annotation is shown in FIG. 5B, which has the same structure as FIG. 5A. For simplicity of explanation, no refinements are shown in the driver tree of FIG. 5B.

In the preferred implementation of the invention, the contributions of contributing leafs and nodes are expressed in percentages, and must therefore combine to be 100% at any given node. Thus, in FIG. 5B, Customer Satisfaction 412 (and 412A) is made up of two-thirds Appropriateness of Product Pricing 426 (and 426A) and one-third Quality of Customer Service 413 (and 413A). Similarly, Brand Image 430 is made up of 45% Appropriateness of Product Pricing 426A, 45% Quality of Customer Service 413A and 10% Customer Satisfaction 412A. The Number of New Customers 440 is made up of 40% Appropriateness of Initial Offer 425, 50% Effectiveness of Acquisition Marketing 435, and 10% Brand Image 430. The Number of Customers Leaving is split fifty-fifty between Customer Satisfaction 412 and Effectiveness of Customer Retention Strategy 445. Finally, the Number of Customers 411 is made up from the Number of New Customers 440 (67%) and the Number of Customers Leaving 416 (33%).

While the influence diagram shown in FIG. 4A and the corresponding driver tree shown in FIG. 5A, and prioritized driver tree with values attached shown in FIG. 5B, only show a segment of the business and do not show the overall value to the business as a primary node, a tree having such a primary node is shown in FIG. 6. However, in order to keep the display reasonably compact, FIG. 6 only shows the topmost levels of the driver tree. In this simplified example, Shareholder Value 610 is made up primarily of a Profit value driver 630 (98%), with lesser amounts for a Debt value driver 620 (1%) and Shareholder/Analyst/Press Confidence 640 (1%). This Public Confidence value driver 640 is itself made up from lower level value drivers (not shown). Total Revenue 660 and Total Cost 650 contribute equally (50% each) to Profit 630. It will be observed that the four contributors to Total Cost 650 sum to 100%: 15% (value driver 652), 25% (value driver 654), 35% (value driver 656) and 25% (value driver 656). Similarly for the contributors to Total Revenue: 10% (value driver 662), 10% (value driver 664), and 80% (value driver 666). Each of these value drivers contributing to Total Cost 650 and Total Revenue 660 is itself made up from lower level value drivers (not shown), which are similarly allocated by percentages so that the total percentage contribution of branch drivers directly contributing to the immediately higher driver is 100%.

The value drivers at the bottom of the value driver tree are termed “leaf drivers”. That is, those drivers at the ends of branches without subordinate branches are “leaf drivers”. For example, returning to FIG. 5A, the following five leaf drivers are identified: 1) appropriateness of product pricing 426, 2) effectiveness of customer retention strategy 445, 3) appropriateness of initial offer 425, 4) effectiveness of acquisition marketing 435, and 5) quality of customer service 413. Note that a driver may appear more than once in the driver tree, as illustrated by a) the customer satisfaction driver (412, 412A) and b) the quality of customer service leaf driver (413, 413A and 413B).

The contribution of each driver has been assessed in relative terms, that is, as a percentage contribution to the immediately superior driver in the driver tree, such that the total of contributions to any driver from its immediate branches (or leaves) is 100%. These quantifications are then used to calculate value driver contributions (as referred to by item 160 in FIG. 1) of any leaf driver to any driver at the head of a tree or sub-tree. This may be done by cascading each of the foregoing percentages from the head driver down to the leaf. Note that this cascading procedure from the head driver down will also calculate the value driver contributions 160 of the intervening drivers, resulting in a list of value drivers with associated values 165.

For example, as shown in FIG. 5B, the contribution of the “appropriateness of product pricing” leaf (426, 426A, and 426B) to the “number of customers” driver 411 may be calculated by following each instance of the leaf up the tree to the driver, multiplying the result by the percentage at each intervening branch, and then adding the instances together. The “appropriateness of product pricing” leaf 426 (at 67%) is connected to the “number of customers” driver 411 by two branch drivers: “customer satisfaction” (at 50%) and “number of customers leaving” (at 33%). Multiplying these three percentages together results in a contribution of 11.06% (67% ×50% ×33%). Similarly, leaf 426A makes a contribution of 0.45% and leaf 426B makes a contribution of 3.02%, resulting in a total contribution of the “appropriateness of product pricing” leaf driver of 14.52%.

The contributions of the other leaf drivers to the “number of customers” driver 411 may be calculated in similar fashion. The results are shown in the following table:

TABLE 1

| | |
|---|---|
| Appropriateness of Product Pricing 426 | 14.52% |
| Effectiveness of Customer Retention Strategy 445 | 16.50% |
| Appropriateness of Initial Offer 425 | 26.80% |
| Effectiveness of Acquisition Marketing 435 | 33.50% |
| Quality of Customer Service 413 | 8.68% |
| TOTAL CONTRIBUTION to Number of Customers 411 | 100.0% |

As is evident from this example, the total contribution of all leaf drivers in a sub-tree to the head driver of the sub-tree must equal 100%. However, a complete driver tree for a real business may have many such sub-trees, all linked to a common driver at the top of the tree. As the calculation proceeds up the tree, sub-trees are combined, as may be understood by reference again to FIG. 5B. The above analysis may be applied separately to each of the sub-trees “Number of Customers Leaving” 416 and “Number of New Customers” 440, as shown by the following two tables.

TABLE 2

| | |
|---|---|
| Appropriateness of Product Pricing 426 | 33.50% |
| Effectiveness of Customer Retention Strategy 445 | 50.00% |
| Quality of Customer Service 413 | 16.50% |
| TOTAL for Number of Customers Leaving 416 | 100.0% |

TABLE 3

| | |
|---|---|
| Appropriateness of Product Pricing 426 | 5.17% |
| Appropriateness of Initial Offer 425 | 40.00% |
| Effectiveness of Acquisition Marketing 435 | 50.00% |
| Quality of Customer Service 413 | 4.83% |
| TOTAL for Number of New Customers 440 | 100.0% |

It will be observed that if the leaf driver percentage contributions in these tables are multiplied by the respective contributions of Number of Customers Leaving 416 (33%) and Number of New Customers 440 (67%), the combination of the two tables is equal to the table for the Number of Customers 411 sub-tree shown above, and repeated below. Note that the leaf drivers in the repeated table have been sorted by contribution.

TABLE 4

| | |
|---|---|
| Effectiveness of Acquisition Marketing 435 | 33.50% |
| Appropriateness of Initial Offer 425 | 26.80% |
| Effectiveness of Customer Retention Strategy 445 | 16.50% |
| Appropriateness of Product Pricing 426 | 14.52% |
| Quality of Customer Service 413 | 8.68% |
| TOTAL CONTRIBUTION to Number of Customers 411 | 100.0% |

Sub-trees can be combined in similar fashion to generate leaf driver percentage contributions to any driver at any level of the driver tree, including the top level of a complete driver tree for a business. The typical driver tree for a business will have many more levels of drivers and branches and many more leaf drivers than shown in the sub-tree example of FIG. 5B and the above tables. It should be noted, of course, consistent with the framework established in the above referenced foundation patent application, that the practical exigencies of applying the invention may require adjustment of the driver tree to accommodate a variable degree of detail or levels of granularity. An exemplar table of leaf driver 710 percentage contributions 715 to the business as a whole (e.g. as measured by shareholder value), sorted in alphabetical order, is shown in FIG. 7.

Once value driver contributions have been calculated for the prioritized driver tree, the business activities related to each leaf value driver are identified, and the relative contribution of each identified business activity to the respective leaf value driver is assessed. For the purposes of illustration, a selection 780 of leaf drivers in FIG. 7 will be used to describe identification of related business activities, i.e. business activities that contribute to the leaf driver. The illustration is shown in FIG. 8A, where each of the selected leaf drivers and their values are expanded in leaf driver column 810 and value column 815, in order to accommodate the plurality of activities contributing to the leaf drivers. The contributing activities are shown in the activity name column 820, with the percentage contribution of each business activity to the leaf driver being shown in contribution column 825.

Note that the sum of contributions (e.g. 828) to a leaf driver total 100%. That is, after the contributing business activities are identified, the relative contribution of each business activity to the total for the leaf driver is determined. Then an activity score 830 is calculated for each identified activity by allocating the leaf driver value shown in value column 815 in accordance with the relative contributions shown in contribution column 825. For example, the 20% contribution 827 of the “brand awareness” activity is applied to the 3.2% value 817 of the “effectiveness of marketing” leaf driver, resulting in an activity score 832 of 0.64% (20% of 3.2%). It follows that the sum of activity scores 830 across the plurality of business activities contributing to a leaf driver is equal to the leaf driver value.

In accordance with the Component Business Model described in the above referenced foundation patent application, each business activity is performed by a business component. The business component responsible for each identified business activity is shown in component column 835. Because a business component is typically responsible for a plurality of business activities, and several of these activities may contribute to a leaf driver, it will be observed that the same component may be listed several times in component column 835 for the same leaf driver. These multiple listings may be collapsed as illustrated in FIG. 8B to show the components 850 responsible for the business activity contributions to each leaf driver 840. For example, the activity score values for two entries of the component “Monitor Influence and Reputation Effectiveness” with respect to the “Effectiveness of marketing” leaf driver in FIG. 8A are combined into a single entry 857 in FIG. 8B. Note also that a given component may be responsible for business activities contributing to more than one leaf driver. For example, in FIG. 8B, the “Employee Management” component is responsible for business activities contributing both to the “Effectiveness of training” leaf driver 858 and the “Employee morale” leaf driver 859.

The illustrations in FIGS. 8A and 8B encompass only a portion of the leaf drivers of the business identified in FIG. 7. However, the illustrations are sufficient to demonstrate that in a complete listing of leaf drivers 840 and components 850, each showing values 855, components may be listed more than once. FIG. 8C shows the result of sorting the complete listing by component 850, collapsing multiple component entries so as to show a combined contribution value 856, and then adding to the list any components that were omitted because they were not responsible for any business activities contributing to the selected and prioritized leaf drivers, i.e. the contribution value 856 for these added components is zero.

The result shown in FIG. 8C is a complete list of components for the business, with relative contribution values for each, showing the relative role that each component plays with respect to the selected and prioritized leaf drivers. This result may then be applied to a component map of the business. It will be recalled from the above referenced foundation patent application that one form of such a map is a matrix of business competencies and management levels within which non-overlapping components are arrayed. Each component displayed on the component map may be overlaid with information from the list of relative contribution values illustrated in FIG. 8C. An example of such an overlay methodology is provided by the category column 860, which is constructed by assignment of the color “Green” to components having a relative contribution value of less than 2%, “Amber” for contribution values between 2% and 5%, and “Red” for contribution values over 5%. Such a display is called a “heat map”, in accordance with the conventions of the above referenced foundation patent application, because it focuses management attention upon those components of the business most germane to leveraging the selected and prioritized value drivers to create value for the business.

Note that the “selected and prioritized leaf drivers” provide a particular context for the determination of activity scores 830 representing the contribution of business activities and their respective components to leaf drivers. The methodology of the invention is flexible and adaptable, so that a change in business conditions or management objectives, or the evolution of the business over time, may result in a different prioritized driver tree and a different selection of leaf drivers, thereby providing a different context and a different heat map. It should further be noted that the work product of application of the methodology of the invention in a particular context may be stored in the repository for possible reuse.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for using value drivers to create value for a business, comprising:
selecting priority value drivers for a business;
developing an influence model showing how the selected value drivers influence one another;
structuring the influence model to provide a link from a measure of overall business value through levels of branches to a plurality of leaf value drivers;
distributing to the leaf value drivers a relative contribution to the overall business value; and
mapping the leaf value drivers to a component map of the business, wherein the relative contributions of the leaf value drivers are aggregated by component.

2. The method of claim 1, wherein selecting priority value drivers further comprises:
using a strategy map to categorize each value driver by impact on a value of the business; and
selecting those value drivers having a high impact on the creation of value for the business.

3. The method of claim 2, wherein each of said drivers has a value that varies up or down over time, said variation in value having a clear link to creation of value for the business.

4. The method of claim 3, wherein the influence model comprises an influence diagram showing for each of said value drivers how said variation in value affects a variation in value for each other value driver.

5. The method of claim 1, wherein said structuring further comprises forming the selected value drivers into a prioritized driver tree.

6. The method of claim 5, wherein said distributing further comprises:
determining relative contributions of each branch within a level; and
cascading relative contributions of value drivers at intervening branches from the overall business value to each leaf driver.

7. The method of claim 6, wherein said mapping further comprises:
identifying business activities contributing to each leaf driver, each identified business activity being performed in a component;
determining for each leaf driver relative contributions of each business activity identified as contributing to said leaf driver;
combining the distributed leaf driver value with the relative contribution of each business activity to produce an activity score for each business activity contributing to the leaf driver;
aggregating activity scores by component; and
using the aggregated activity scores to overlay a heat map upon the component map of the business.

8. The method of claim 7, wherein the relative contributions are expressed as percentages and the heat map overlay is established by defining a higher and a lower threshold percentage, with those components having relative contributions above the higher threshold being distinguished on the component map from those components having relative contributions between the higher and lower thresholds, and being further distinguished on the component map from those components having relative contributions below the lower threshold.

9. A system for using value drivers to create value for a business, comprising:
means for selecting priority value drivers for a business;
means for developing an influence model showing how the selected value drivers influence one another;
means for structuring the influence model to provide a link from a measure of overall business value through levels of branches to a plurality of leaf value drivers;
means for distributing to the leaf value drivers a relative contribution to the overall business value; and
means for mapping the leaf value drivers to a component map of the business, wherein the relative contributions of the leaf value drivers are aggregated by component.

10. The system of claim 9, wherein the means for selecting priority value drivers further comprises:
means for using a strategy map to categorize each value driver by impact on a value of the business; and
means for selecting those value drivers having a high impact on the creation of value for the business.

11. The system of claim 10, wherein each of said drivers has a value that varies up or down over time, said variation in value having a clear link to creation of value for the business.

12. The method of claim 11, wherein the influence model comprises an influence diagram showing for each of said value drivers how said variation in value affects a variation in value for each other value driver.

13. The system of claim 9, wherein said structuring means further comprises means for forming the selected value drivers into a prioritized driver tree.

14. The system of claim 13, wherein said distributing means further comprises:
means for determining relative contributions of each branch within a level; and
means for cascading relative contributions of value drivers at intervening branches from the overall business value to each leaf driver.

15. The system of claim 14, wherein said mapping means further comprises:
means for identifying business activities contributing to each leaf driver, each identified business activity being performed in a component;
means for determining for each leaf driver relative contributions of each business activity identified as contributing to said leaf driver;
means for combining the distributed leaf driver value with the relative contribution of each business activity to produce an activity score for each business activity contributing to the leaf driver;
means for aggregating activity scores by component; and
means for using the aggregated activity scores to overlay a heat map upon the component map of the business.

16. The system of claim 15, wherein the relative contributions are expressed as percentages and the heat map overlay is established by defining a higher and a lower threshold percentage, with those components having relative contributions above the higher threshold being distinguished on the component map from those components having relative contributions between the higher and lower thresholds, and being further distinguished on the component map from those components having relative contributions below the lower threshold.

17. Implementing a service for using value drivers to create value for a business, comprising the method of
selecting priority value drivers for a business;
developing an influence model showing how the selected value drivers influence one another;
structuring the influence model to provide a link from a measure of overall business value through levels of branches to a plurality of leaf value drivers;
distributing to the leaf value drivers a relative contribution to the overall business value; and
mapping the leaf value drivers to a component map of the business, wherein the relative contributions of the leaf value drivers are aggregated by component.

18. A method implementing a service as in claim 17, wherein said structuring further comprises forming the selected value drivers into a prioritized driver tree, and wherein said distributing further comprises determining relative contributions of each branch within a level and cascading relative contributions of value drivers at intervening branches from the overall business value to each leaf driver.

19. A method implementing a service as in claim 18, wherein said mapping further comprises:
identifying business activities contributing to each leaf driver, each identified business activity being performed in a component;
determining for each leaf driver relative contributions of each business activity identified as contributing to said leaf driver;
combining the distributed leaf driver value with the relative contribution of each business activity to produce an activity score for each business activity contributing to the leaf driver;
aggregating activity scores by component; and
using the aggregated activity scores to overlay a heat map upon the component map of the business.

20. A method implementing a service as in claim 19, wherein the relative contributions are expressed as percentages and the heat map overlay is established by defining a higher and a lower threshold percentage, with those components having relative contributions above the higher threshold being distinguished on the component map from those components having relative contributions between the higher and lower thresholds, and being further distinguished on the component map from those components having relative contributions below the lower threshold.
